(19) United States
(12) Patent Application Publication
(10) Pub. No.: US 2012/0178574 A1
(43) Pub. Date: Jul. 12, 2012

(54) MOTOR MODULE ASSEMBLY

(75) Inventors: Edwin T. Grochowski, Howell, MI (US); James M. Hart, Belleville, MI (US)

(73) Assignee: GM GLOBAL TECHNOLOGY OPERATIONS LLC, DETROIT, MI (US)

(21) Appl. No.: 13/348,768

(22) Filed: Jan. 12, 2012

Related U.S. Application Data
(60) Provisional application No. 61/432,134, filed on Jan. 12, 2011.

(51) Int. Cl. F16H 57/08; H02K 9/193

(52) U.S. Cl. 475/149; 310/54; 903/910; 903/912

(57) ABSTRACT

A powertrain for a hybrid electric vehicle includes an engine, an electric motor module, and a transmission. The electric motor module includes a hydraulic cooling circuit for the electric motor. The hydraulic cooling circuit includes a fluid passage and an annulus in fluid communication with the fluid passage. The annulus is radially outwardly disposed relative to a stator of an electric motor for circulating hydraulic fluid around an outer circumference of the stator.

### CROSS-REFERENCE TO RELATED APPLICATIONS

This application claims the benefit of U.S. Provisional Application No. 61/432,134 filed on Jan. 12, 2011. The disclosure of the above application is incorporated herein by reference.

### FIELD

The invention relates generally to a powertrain module, and more particularly to a powertrain module that includes an electric motor and a motor cooling circuit.

### BACKGROUND

The statements in this section merely provide background information related to the present disclosure and may or may not constitute prior art.

A hybrid electric vehicle is a vehicle having a propulsion system that consists of at least one electric motor or electric machine in combination with at least one other power source. Typically, the other power source is a gasoline or diesel engine. There are various types of hybrid electric vehicles depending on how the electric motor(s) and other power source(s) are combined with one another in order to provide propulsion for the vehicle, including series, parallel, and compound hybrid electric vehicles.

Parallel hybrid electric vehicle architectures are generally characterized by an internal combustion engine and an electric motor, which both have a direct mechanical coupling to the drivetrain. The drivetrain conventionally includes a multiple speed automatic transmission to provide the necessary gear ratios for wide range operation.

A typical multiple speed automatic transmission uses a combination of friction clutches and brakes, planetary gear arrangements and fixed interconnections to achieve a plurality of gear ratios. The number and physical arrangement of the clutches and brakes, generally, are dictated by packaging, cost and desired speed ratios.

While current hybrid electric vehicle arrangements achieve their intended purpose, the need for new and improved arrangements that exhibit improved characteristics, especially from the standpoints of efficiency, responsiveness and smoothness and improved packaging, primarily reduced size and weight, is essential. Accordingly, there is a need for an improved, cost-effective, compact hybrid electric vehicle arrangement.

### SUMMARY

A powertrain for a hybrid electric vehicle includes an engine, an electric motor module, and a transmission. The electric motor module includes a hydraulic cooling circuit for the electric motor. The hydraulic cooling circuit includes a fluid passage and an annulus in fluid communication with the fluid passage. The annulus is radially outwardly disposed relative to a stator of an electric motor for circulating hydraulic fluid around an outer circumference of the stator.

In another aspect of the present invention, a motor module assembly for a transmission of a vehicle is provided. The motor module assembly includes a clutch, a module housing, an electric motor, and a fluid passageway. The clutch includes a first member and a second member selectively engageable with the first member. The first member is connectable with an input member of the transmission and has an axis of rotation and the second member is connectable with an engine output member of the vehicle. The module housing includes an annular member, a first wall member, and a second wall member. The annular member defines an annulus that opposes the second member of the clutch and the first wall member and the second wall member are substantially disc shaped and substantially perpendicular to the axis of rotation of the second member. The module housing, the first wall member, and the second wall member define a cavity and substantially restrict fluid from exiting the cavity. The electric motor includes a rotor and a stator and is disposed in the cavity. The rotor is rotationally coupled with the second member of the clutch and the stator opposes the rotor and is rotationally coupled with the module housing radially inward of the annulus of the annular member of the module housing. The fluid passageway is in fluid communication with the annulus of the first portion of the module housing.

In yet another aspect of the present invention, the motor module further includes a first fluid seal and a second fluid seal. The first fluid seal is disposed between the first member of the clutch and the second wall member of the module housing and the second fluid seal is disposed between the first wall member of the module housing and the second member of the clutch.

In yet another aspect of the present invention, the motor module further includes a fluid drain passageway disposed at a bottom portion of the module housing.

In yet another aspect of the present invention, the fluid passageway is disposed at a top portion of the module housing.

In yet another aspect of the present invention, the clutch is a wet clutch.

In yet another aspect of the present invention, the clutch includes a plurality of friction discs.

In yet another aspect of the present invention, the motor module further includes an annular plate disposed between the stator of the electric motor and the annulus of the annular member of the module housing.

In yet another aspect of the present invention, the annular plate includes a plurality of apertures extending in a radial direction through the annular plate.

Further aspects and advantages of the present invention will become apparent by reference to the following description and appended drawings wherein like reference numbers refer to the same component, element or feature.

### DRAWINGS

The drawings described herein are for illustration purposes only and are not intended to limit the scope of the present disclosure in any way.

FIG. 1 is a schematic diagram of a powertrain according to the principles of the present invention; and

FIG. 2 is a cross sectional view of an embodiment of an electric motor module according to the principles of the present invention.

### DETAILED DESCRIPTION

The following description is merely exemplary in nature and is not intended to limit the present disclosure, application, or uses.

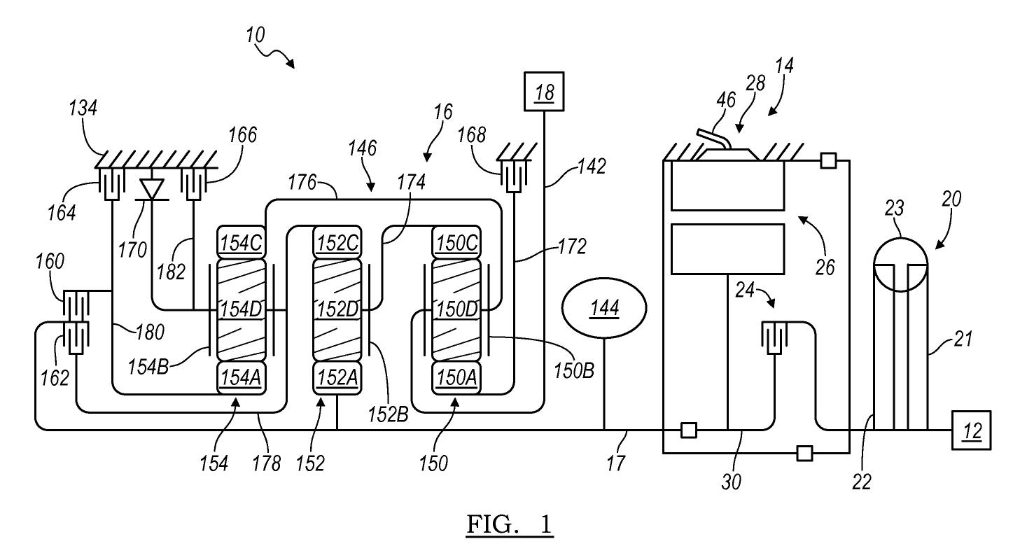

With reference to FIG. 1, an exemplary powertrain for a motor vehicle is generally indicated by reference number 10. The powertrain 10 includes an engine 12 and an electric motor module 14 that supply a driving torque to a transmission 16 through a transmission input member 17, which supplies various gear or speed ratios to a final drive unit 18. The engine 12 may be a conventional internal combustion engine or an electric engine, or any other type of prime mover, without departing from the scope of the present disclosure. A vibration absorber 20 includes a first member 21, a second member 22, and a plurality of resilient members or springs 23. The first member 21 is rotationally coupled with an output of the engine and the springs 23 rotationally couple the first member 21 to the second member 22. The vibration absorber 20 is configured to absorb a portion of torque oscillations transmitted through the first member 21 from the engine 12. The vibration absorber 20 may take various forms and have various properties without departing from the scope of the present disclosure.

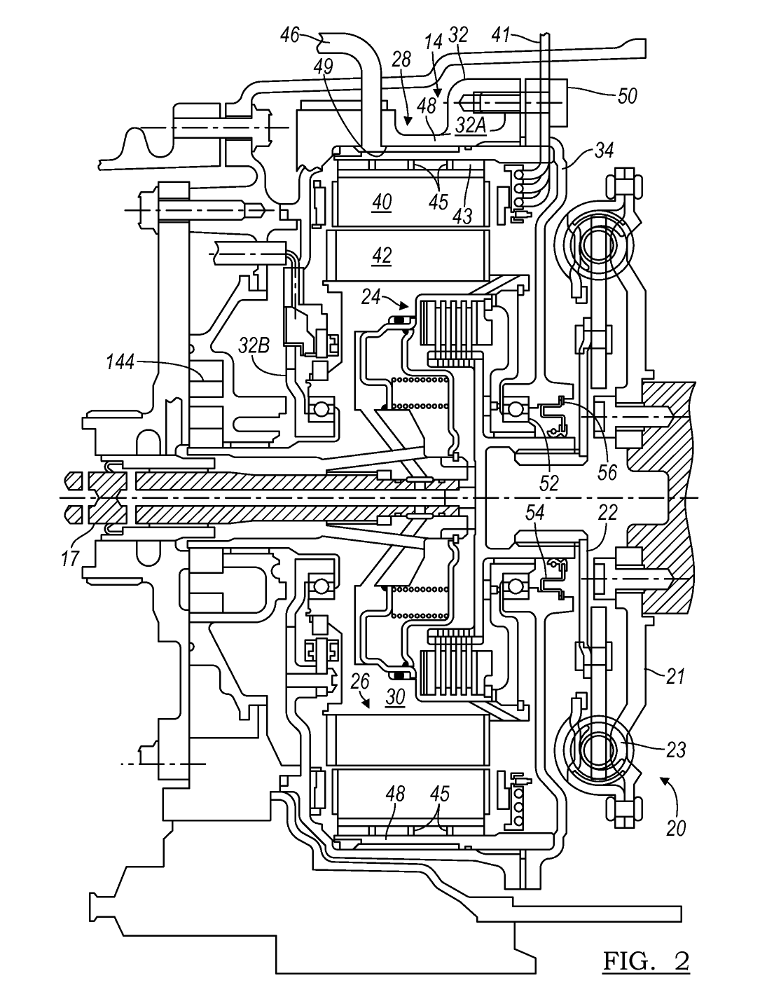

With further reference to FIG. 2, and with continued reference to FIG. 1, a cross sectional view of an embodiment of an electric motor module 14 is shown. The electric motor module 14 includes a disconnect clutch 24, an electric motor 26, a motor cooling circuit 28, a hub member 30, a housing 32, and a cover member 34. The motor module 14 is substantially sealed to limit fluid flow past the housing 32 and the cover 34. The disconnect clutch 24 is, in the example provided, a plate clutch that when applied transmits torque from the first second member 22 of the vibration absorber 20 to the hub member 30. It should be appreciated that various types of torque transmitting devices may be employed without departing from the scope of the present invention.

The electric motor 26 generally includes a stator 40 and a rotor 42. The stator 40 is secured the housing 32 and is therefore stationary. The stator 40 includes a plurality of field windings or coils (not shown) to generate magnetic fields on the rotor 42. Electric power is provided to the stator 40 through electrical conductors or cables 41, which pass through the housing 32 in suitable feedthroughs (not illustrated). A circumferential or annular plate or separator 43 defining a plurality of through radial openings or apertures 45 evenly distributes the cooling oil around the stator 40. The rotor 42 is disposed radially inward of the stator 40 and is fixed for common rotation with the hub 30.

The motor cooling circuit 28 includes a hydraulic passage 46 and an annulus or annular fluid passage 48. The hydraulic passage 46 communicates hydraulic fluid or cooling oil from a pressure source to the annulus 48. The annulus 48 is a ring shaped fluid passageway defined between the housing 32 and the stator 40 of the electric motor 26. In the example provided the housing 32 defines the annular groove 48 with an inner surface 49. The annulus 48 communicates and distributes the fluid from the passage 46 around the outer circumference of the separator 43 and through the apertures 45 to the stator 40 for cooling the stator 40 and the coils. In the example provided the fluid drains from the bottom of the motor module 14 to a sump (not shown).

The hub member 30 is rotationally coupled with the rotor 42 of the motor 26, the transmission input member 17, and is selectively coupled with the second member 22 of the vibration absorber 20 through the clutch 24. In alternative embodiments, the hub 30 transmits torque to the transmission input member 17 through a second vibration absorber (not shown).

The housing 32 is annular in shape and is secured to a housing of the transmission 16. The cover 34 is secured to the housing 32 by fastening devices 50. It should be appreciated that the cover and the housing 32 may be connected in other ways without departing from the scope of the present invention. The housing 32 includes a first portion 32A and a second portion 32B. The first portion 32A is substantially ring shaped and circumscribes the electric motor 26 and the hub 30. The second portion 32B is substantially disc shaped and opposes the cover 34. The cover 34 is generally disc shaped and is radially aligned with the second member 22 of the vibration absorber 20 by bearings 52. A seal 54 is disposed between the cover 34 and the second member 22 of the vibration absorber 20 and secured by a snap ring 56 to prevent fluid flow from the motor module 14 to the vibration absorber 20. Accordingly, the housing 32, cover 34, and plate member 56 substantially contain lubrication and cooling fluid distributed through the motor module 14.

The transmission 16 generally includes a transmission input shaft 17, a transmission output shaft 142, a pump 144, and a clutch and gear arrangement 146. The transmission input shaft 17 is connected for common rotation with the hub 30 of the electric motor module 14. In addition, the pump 144 is connected to and driven by the transmission input shaft 17. The pump 144 may be any positive displacement pump, such as a gerotor pump or a vane pump, operable to provide pressurized hydraulic fluid to both the transmission 16 and the electric motor module 14. In the example provided, the pump 144 provides pressurized hydraulic fluid to the motor cooling circuit 28.

The gear and clutch arrangement 146 includes a plurality of planetary gear assemblies 150, 152, and 154 interconnected with a plurality of torque transmitting mechanisms 160, 162, 164, 166, 168, and 170. For example, the first planetary gear set 150 includes a sun gear member 150A, a planet gear carrier member 150B and a ring gear member 150C. The sun gear member 150A is connected for common rotation with a first shaft or interconnecting member 172. The ring gear member 150C is connected for common rotation with a second shaft or interconnecting member 174. The planet gear carrier member 150B rotatably supports a set of planet gears 150D (only one of which is shown) and is connected for common rotation with the transmission output shaft or member 142 and a third shaft or interconnecting member 176. The planet gears 150D are each configured to intermesh with both the sun gear member 150A and the ring gear member 150C.

The second planetary gear set 152 includes a sun gear member 152A, a planet carrier member 152B that rotatably supports a set of planet gears 152D and a ring gear member 152C. The sun gear member 152A is connected for common rotation with the transmission input shaft or member 17. The ring gear member 152C is connected for common rotation with a fourth shaft or interconnecting member 178. The planet carrier member 152B is connected for common rotation with the second shaft or interconnecting member 174. The planet gears 152D are each configured to intermesh with both the sun gear member 152A and the ring gear member 152C.

The third planetary gear set 154 includes a sun gear member 154A, a ring gear member 154C and a planet carrier member 154B that rotatably supports a set of planet gears 154D. The sun gear member 154A is connected for common rotation with a fifth shaft or interconnecting member 180. The ring gear member 154C is connected for common rotation with the third shaft or interconnecting member 176. The planet carrier member 154B is connected for common rotation with the fourth shaft or interconnecting member 178 and a sixth shaft or interconnecting member 182. The planet gears 154D are each configured to intermesh with both the sun gear member 154A and the ring gear member 154C.

The torque-transmitting mechanisms or clutches 160, 162 and brakes 164, 166, 168, 170 allow for selective interconnection of the shafts or interconnecting members, members of the planetary gear sets and the transmission housing. For example, the first clutch 160 is selectively engageable to connect the fifth interconnecting member 180 with the transmission input member 17. The second clutch 162 is selectively engageable to connect the fourth interconnecting member 178 with the transmission input member 17. The first brake 164 is selectively engageable to connect the fifth interconnecting member 180 to the stationary member or transmission housing 134 in order to restrict the member 180 from rotating relative to the stationary member or transmission housing 134. The second brake 166 is selectively engageable to connect the sixth interconnecting member 182 to the stationary member or transmission housing 134 in order to restrict the member 182 from rotating relative to the stationary member or transmission housing 134. The third brake 168 is selectively engageable to connect the first interconnecting member 172 to the stationary member or transmission housing 134 in order to restrict the member 172 from rotating relative to the stationary member or transmission housing 134. The fourth brake 170 is a one-way clutch that is selectively engageable to connect the sixth interconnecting member 182 to the stationary member or transmission housing 134 in order to restrict the member 182 from rotating relative to the stationary element or transmission housing 134 in a first rotational direction.

The transmission output shaft or member 142 is preferably continuously connected with the final drive unit or transfer case 18. The final drive unit 18 may include a differential, trans-axles, and wheels (not shown) for providing a final output torque.

The present invention provides beneficial packaging characteristics and capability of integrating into various powertrains. In addition, the electric motor cooling capability improves the performance and reliability of the powertrain.

The description of the invention is merely exemplary in nature and variations that do not depart from the gist of the invention are intended to be within the scope of the invention. Such variations are not to be regarded as a departure from the spirit and scope of the invention.

What is claimed is:

1. A motor module assembly for a transmission of a vehicle, the motor module assembly comprising:
a clutch including a first member and a second member selectively engageable with the first member, wherein the first member is connectable with an engine output member of the vehicle and has an axis of rotation, and wherein the second member is connectable with an input member of the transmission;
a module housing including an annular member, a first wall member, and a second wall member, wherein the annular member defines an annulus that opposes the second member of the clutch, and wherein the first wall member and the second wall member are substantially disc shaped and substantially perpendicular to the axis of rotation of the second member, and wherein the module housing, the first wall member, and the second wall member define a cavity and substantially restrict fluid from exiting the cavity;
an electric motor including a rotor and a stator and disposed in the cavity, wherein the rotor is rotationally coupled with the second member of the clutch and the stator opposes the rotor and is rotationally coupled with the module housing radially inward of the annulus of the annular member of the module housing; and
a fluid passageway in fluid communication with the annulus of the first portion of the module housing.

2. The motor module assembly of claim 1 further including a first fluid seal and a second fluid seal, wherein the first fluid seal is disposed between the first member of the clutch and the second wall member of the module housing, and wherein the second fluid seal is disposed between the first wall member of the module housing and the second member of the clutch.

3. The motor module assembly of claim 1 further including a fluid drain passageway disposed at a bottom portion of the module housing.

4. The motor module assembly of claim 1 wherein the fluid passageway is disposed at a top portion of the module housing.

5. The motor module assembly of claim 1 wherein the clutch is a wet clutch.

6. The motor module assembly of claim 1 wherein the clutch includes a plurality of friction discs.

7. The motor module assembly of claim 1 further including an annular plate disposed between the stator of the electric motor and the annulus of the annular member of the module housing.

8. The motor module assembly of claim 7 wherein the annular plate includes a plurality of apertures extending in a radial direction through the annular plate.

9. A vehicle transmission comprising:
a transmission housing;
a plurality of gear sets each including a ring gear, sun gear, and carrier member;
a plurality of torque transmitting devices each selectively connectable to rotationally couple at least one of the ring gears, sun gears, and carrier members with at least one other of the transmission housing, the ring gears, sun gears, and the carrier members;
a first shaft connectable with an output shaft of an engine;
a second shaft rotationally coupled with at least one of the ring gears, sun gears, and carrier members of the plurality of gear sets; and
a motor module fixed to the transmission housing, the motor module including:
a clutch including a first member and a second member selectively engageable with the first member, wherein the first member is rotationally coupled with the first shaft and has an axis of rotation, and wherein the second member is rotationally coupled with the second shaft;
a module housing including an annular member, a first wall member, and a second wall member, wherein the annular member defines an annulus that opposes the second member of the clutch, and wherein the first wall member and the second wall member are substantially disc shaped and substantially perpendicular to the axis of rotation of the second member, and wherein the module housing, the first wall member, and the second wall member define a cavity and substantially restrict fluid from exiting the cavity;
an electric motor including a rotor and a stator and disposed in the cavity, wherein the rotor is rotationally coupled with the second member of the clutch and the stator opposes the rotor and is rotationally coupled with the module housing radially inward of the annulus of the annular member of the module housing; and
a fluid passageway in fluid communication with the annulus of the first portion of the module housing.

10. The vehicle transmission of claim 9 wherein the motor module further comprises a first fluid seal and a second fluid seal, wherein the first fluid seal is disposed between the first member of the clutch and the second wall member of the module housing, and wherein the second fluid seal is disposed between the first wall member of the module housing and the second member of the clutch.

11. The vehicle transmission of claim 9 wherein the motor module further comprises a fluid drain passageway disposed at a bottom portion of the module housing.

12. The vehicle transmission of claim 9 wherein the fluid passageway of the motor module is disposed at a top portion of the module housing.

13. The vehicle transmission of claim 9 wherein the clutch of the motor module is a wet clutch.

14. The vehicle transmission of claim 9 wherein the clutch of the motor module includes a plurality of friction discs.

15. The vehicle transmission of claim 9 wherein the motor module further comprises an annular plate disposed between the stator of the electric motor and the annulus of the annular member of the module housing.

16. The vehicle transmission of claim 15 wherein the annular plate of the motor module includes a plurality of apertures extending in a radial direction through the annular plate.

17. The vehicle transmission of claim 9 further comprising a vibration absorber rotationally coupled with the first shaft of the vehicle transmission.

18. The vehicle transmission of claim 9 further comprising a hydraulic pump in fluid communication with the fluid passageway of the motor module.

19. The vehicle transmission of claim 9 wherein the motor module housing is bolted to the transmission housing.

20. The vehicle transmission of claim 9 wherein the second wall member of the module housing is bolted to the annular member of the module housing.
